(19) United States
(12) Patent Application Publication
(10) Pub. No.: US 2024/0396039 A1
(43) Pub. Date: Nov. 28, 2024

(54) PRODUCTION METHOD OF POROUS SILICON CLATHRATE ELECTRODE ACTIVE MATERIAL AND PRODUCTION METHOD OF LITHIUM-ION BATTERY

(71) Applicant: TOYOTA JIDOSHA KABUSHIKI KAISHA, Toyota-shi (JP)

(72) Inventors: Naohiro MASHIMO, Atsugi-shi (JP); Mitsutoshi OTAKI, Susono-shi (JP); Jun YOSHIDA, Mishima-shi (JP)

(73) Assignee: TOYOTA JIDOSHA KABUSHIKI KAISHA, Toyota-shi (JP)

(21) Appl. No.: 18/415,996

(22) Filed: Jan. 18, 2024

(30) Foreign Application Priority Data
May 24, 2023 (JP) 2023-085318

(51) Int. Cl. H01M 4/58; C01B 33/021

(52) U.S. Cl. CPC H01M 4/58; C01B 33/021; C01P 2006/40

(57) ABSTRACT

The disclosed methods of making porous silicon clathrate electrode active materials include (a) providing a composition comprising silicon clathrate particles comprising a type I silicon clathrate and a type II silicon clathrate, and (b) removing at least a portion of the type I silicon clathrate to form pores in the silicon clathrate particles or increasing pores in the silicon clathrate particles.

### CROSS-REFERENCE TO RELATED APPLICATION

This application claims priority to Japanese Patent Application No. 2023-085318 filed on May 24, 2023, incorporated herein by reference in its entirety.

### BACKGROUND

### 1. Technical Field

The present disclosure relates to a production method of a porous silicon clathrate electrode active material and a production method of a lithium-ion battery.

### 2. Description of Related Art

In recent years, development of batteries has been actively pursued. For example, batteries for use in battery electric vehicles and hybrid electric vehicles are being developed in the automotive industry. Also, silicon is known as an electrode active material used in batteries, and particularly in lithium-ion batteries.

Such silicon electrode active material has a great theoretical capacity and is effective for increasing energy density of batteries. On the other hand, silicon electrode active material has a problem that expansion during charging is large. Conversely, suppressing expansion during charging by using a silicon clathrate electrode active material as the silicon electrode active material is known.

For example, Japanese Unexamined Patent Application Publication No. 2021-158004 (JP 2021-158004 A) discloses a silicon clathrate electrode active material with a crystalline phase of type II silicon clathrate, having voids inside primary particles, in which void amounts of the voids with pore diameters of 100 nm or less are 0.05 cc/g or more and 0.15 cc/g or less.

### SUMMARY

Types of silicon clathrate crystals include type I silicon clathrate and type II silicon clathrate. In particular, in type II silicon clathrate, lithium is efficiently occluded in cage structures of the crystals. Accordingly, the expansion and contraction of type II silicon clathrate when batteries are charged and discharged is small.

Also, silicon clathrate particles having pores absorb expansion that occurs due to charging of batteries, by their pores, and accordingly can reduce expansion during charging.

In view of such circumstances, developing of a method for producing silicon clathrate particles having a high content proportion of type II silicon clathrate and also having a great amount of pores, is desired.

An object of the present disclosure is to provide a production method of a porous silicon clathrate electrode active material having a high content proportion of type II silicon clathrate and also having a great amount of pores, and a production method of a lithium-ion battery including producing such a silicon clathrate electrode active material.

The disclosers of the present disclosure found that the above problem can be solved by the following means.

### First Aspect

A production method of a porous silicon clathrate electrode active material, the production method including
(a) providing a composition including silicon clathrate particles containing a type I silicon clathrate and a type II silicon clathrate, and
(b) removing at least part of the type I silicon clathrate to form pores in the silicon clathrate particles, or to increase pores in the silicon clathrate particles.

### Second Aspect

The production method according to the First Aspect, wherein a proportion of mass of the type I silicon clathrate as to a total mass of the composition containing the silicon clathrate particles is 5.0% by mass or more.

### Third Aspect

The production method according to the First Aspect, wherein in (b), the silicon clathrate particles are brought into contact with a hydrogen fluoride solution to remove at least part of the type I silicon clathrate.

### Fourth Aspect

The production method according to the Third Aspect, wherein a solvent of the hydrogen fluoride solution is a mixed solvent of water and an organic solvent.

### Fifth Aspect

The production method according to the First Aspect, wherein the silicon clathrate electrode active material is used for a cathode active material of a lithium-ion battery.

### Sixth Aspect

A production method of a lithium-ion battery, the production method including:
producing a silicon clathrate electrode active material by the production method according to the First Aspect; and
forming an electrode active material layer containing the silicon clathrate electrode active material.

According to the method of the disclosure for producing porous silicon clathrate electrode active material, silicon clathrate particles that have a high content proportion of type II silicon clathrate and also have a great amount of pores can be produced. Also, the present disclosure can provide a production method of a lithium-ion battery including production of such a silicon clathrate electrode active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relation between the content ratio of the type I silicon clathrate in the composition containing the silicon clathrate particles and the increased amount of the pores below 100 nm after removing the type I silicon clathrate.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Production Method of Porous Silicon Clathrate Electrode Active Material

The disclosed methods of making porous silicon clathrate electrode active materials include (a) providing a composition comprising silicon clathrate particles comprising a type I silicon clathrate and a type II silicon clathrate, and (b) removing at least a portion of the type I silicon clathrate to form pores in the silicon clathrate particles or increasing pores in the silicon clathrate particles.

The Disclosing Party has found that there are differences in solubility in certain solutions, particularly hydrofluoric (HF) solutions, between type I and type II silicon clathrates. That is, the type I silicon clathrate has higher solubility in HF solutions than type II silicon clathrate. Accordingly, the Disclosing Part has found that the pores can be formed in the silicon clathrate particles or the pores of the silicon clathrate particles can be increased by dissolving and removing the type I silicon clathrate from the silicon clathrate particles containing the type I silicon clathrate and the type II silicon clathrate using HF solutions or the like, thereby forming the pores in the silicon clathrate particles at the locations where the type I silicon clathrate was present.

This makes it possible to obtain a porous silicon clathrate having a small expansion during charging.

In the present disclosure, the “electrode active material” can be used as an “anode active material” or a “cathode active material”, and is particularly used as a “cathode active material”.

### Provision of a Composition Comprising Silicon Clathrate Particles

The present disclosure relates to a composition including silicon clathrate particles comprising a type I silicon clathrate and a type II silicon clathrate.

Compositions comprising such silicon clathrate particles can be prepared by preparing a sodium silicon (NaSi) alloy and removing the sodium from NaSi alloy.

Specifically, a NaSi is prepared by first reacting a silicon source with a sodium source, such as sodium hydride. NaSi alloy thus prepared can then be heated to remove the sodium from NaSi alloy and clathrate to prepare a composition comprising silicon clathrate particles. Alternatively, a composition comprising silicon clathrate particles can be prepared by reacting NaSi alloy thus prepared with aluminum fluoride as a sodium trapping agent to remove sodium from NaSi alloy and clathrate it.

In the composition containing silicon clathrate particles that can be used as a raw material in the method of the present disclosure, the ratio of the mass of the type I silicon clathrate to the total mass of the composition containing the silicon clathrate particles may be 5.0% by mass or more, 6.0% by mass or more, 6.5% by mass or more, 6.8% by mass or more, or 7.0% by mass or more, and may be 12.0% by mass or less, 10.0% by mass or less, 9.0% by mass or less, 8.5% by mass or less, or 8.0% by mass or less.

Incidentally, the content ratio of the type I silicon clathrate and the type II silicon clathrate in the silicon clathrate particles can be calculated, for example, from the peak intensity ratio measured by X-ray diffractometry (XRD).

### Removal of Type I Silicon Clathrate

The method of the present disclosure includes removing at least a portion of the type I silicon clathrate to form pores in the silicon clathrate particles, or increasing the pores of the silicon clathrate particles.

The silicon clathrate particles may be contacted with a hydrogen fluoride solution to remove at least a portion of the type I silicon clathrate.

The solvent of the hydrogen fluoride solution may be water, an organic solvent, or a mixed solvent of water and an organic solvent. When the solvent contains water, i.e., water or a mixed solvent of water and an organic solvent, particularly a mixed solvent of water and an organic solvent, it is preferable to suppress the formation of by-products such as sodium silicofluoride (Na₂SiF₆).

It is preferable that the solvent contains an organic solvent in view of reducing the amount of water remaining in the silicon clathrate electrode active material. The proportion of the organic solvent in the solution may be 80% by mass or more, 90% by mass or more, or 95% by mass or more.

The organic solvent may be any organic solvent capable of dissolving hydrogen fluoride. When the organic solvent is mixed with water, any organic solvent capable of dissolving hydrogen fluoride and compatible with water may be used. The organic solvent is preferably an alcohol, more preferably a lower alcohol, and even more preferably ethanol.

In the disclosed process, the ratio (HF [mol]/Si [g]) of the amount of hydrogen fluoride (mol) to the mass (g) of the silicon clathrate may be 0.006 mol/g or more, 0.01 mol/g or more, 0.02 mol/g or more, 0.03 mol/g or more, 0.04 mol/g or more, or 0.05 mol/g or more, and may be 0.20 mol/g or less, 0.15 mol/g or less, 0.13 mol/g or less, or 0.11 mol/g or less, or 0.25 mol/g or less. When the ratio is within the above range, the type I silicon clathrate can be selectively removed from the silicon clathrate particles.

Examples of the method of contacting include, but are not limited to, a mixing operation such as stirring.

The time of contact may be 0.5 hours or more, 1 hour or more, or 2 hours or more, and may be 6 hours or less, 5 hours or less, or 4 hours or less.

In the silicon clathrate electrode active material produced in the disclosed methods, the ratio of the mass of type II silicon clathrate to the total mass of the type I silicon clathrate and the type II silicon clathrate may be 93.5% by mass or more, 94.0% by mass or more, 95.0% by mass or more, 96.0% by mass or more, 97.0% by mass or more, 98.0% by mass or more, or 99.0% by mass or more.

The silicon clathrate particles may comprise pores of less than or equal to the diameter of 100 nm.

In the disclosed process, the pores contained in the silicon clathrate particles, in particular pores below the diameter of 100 nm, can be increased by step (b). The increase amount of pores can be calculated as the difference between the amount of pores after step (b) and the amount of pores before step (b).

The increased amount of the pores having the diameter 100 nm or less may be 0.01 cc/g or more, 0.03 cc/g or more, 0.04 cc/g or more, 0.05 cc/g or more, or 0.06 cc/g or more. The increased amount may be 0.50 cc/g or less, 0.40 cc/g or less, 0.30 cc/g or less, 0.25 cc/g or less, 0.20 cc/g or less, 0.17 cc/g or less, or 0.15 cc/g or less.

### Use

The silicon clathrate electrode active material in the method of the present disclosure can be used for a cathode active material of a lithium-ion battery.

### Production Method of Lithium-Ion Battery

A method of the present disclosure for fabricating a lithium-ion battery includes fabricating a silicon clathrate electrode active material by a method of the present disclosure and forming an electrode active material layer containing the silicon clathrate electrode active material.

Regarding the production method of the silicon clathrate electrode active material, the above description regarding the production method of the silicon clathrate electrode active material of the present disclosure can be referred to.

A method of forming the electrode active material layer is not particularly limited, and a known method can be employed. For example, when the cathode active material layer contains the silicon clathrate electrode active material of the present disclosure, a slurry containing the silicon clathrate electrode active material is applied to the cathode current collector and dried, whereby an electrode active material layer formed on the cathode current collector layer, that is, a cathode active material layer can be obtained.

The method of forming the battery is not particularly limited, and a known method can be employed. Hereinafter, a production method of a battery in a case where the cathode active material layer contains the silicon clathrate electrode active material of the present disclosure will be described.

A production method of a battery according to the present disclosure may include, in addition to manufacturing a silicon clathrate electrode active material and forming a cathode active material layer containing a silicon clathrate electrode active material, disposing a cathode current collector layer, a cathode active material layer, an electrolyte layer, an anode active material layer, and an anode current collector layer in this order.

### Cathode Current Collector Layer

The material used for the cathode current collector layer is not particularly limited, and a material that can be used as a cathode current collector of a battery can be appropriately employed. For example, the material used for the cathode current collector layer may be, but is not limited to, copper, a copper alloy, and copper plated or deposited with nickel, chromium, carbon, and the like.

The shape of the cathode current collector layer is not particularly limited, and may be, for example, a foil shape, a plate shape, or a mesh shape. Among the above, the foil shape is preferred.

### Cathode Active Material Layer

The cathode active material layer of the present disclosure is a layer containing a cathode active material, and optionally an electrolyte, a conductive auxiliary agent, and a binder.

### Cathode Active Material

The cathode active material includes the silicon clathrate electrode active material of the present disclosure.

### Electrolyte

The material of the solid electrolyte is not particularly limited, and a material that can be used as a solid electrolyte used in a lithium-ion battery can be used. For example, the solid electrolyte may be a sulfide solid electrolyte.

Examples of sulfide solid electrolytes include, but are not limited to, sulfide amorphous solid electrolytes, sulfide crystalline solid electrolytes, or argyrodite solid electrolytes. Specific examples of sulfide solid electrolyte include Li₂S—P₂S₅-based materials (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof, but are not limited to these.

The sulfide solid electrolyte may be glass or crystallized glass (glass ceramic).

When the cathode active material layer contains a solid electrolyte, the mass ratio of the silicon clathrate electrode active material to the solid electrolyte in the cathode active material layer (mass of the silicon clathrate electrode active material:mass of the solid electrolyte) is preferably 85:15 to 30:70, and more preferably 80:20 to 40:60.

The electrolyte preferably contains a supporting salt and a solvent.

Examples of the supporting salt (lithium salt) of the electrolyte having lithium ion conductivity include inorganic lithium salts such as LiPF₆, LiBF₄, LiClO₄ and LiAsF₆ and organic lithium salts such as LiCF₃SO₃, Lin(CF₃SO₂)₂, Lin (C₂F₅SO₂)₂, LiN(FSO₂)₂, and LiC(CF₃SO₂)₃.

Examples of solvents used in the electrolyte include cyclic esters (cyclic carbonates) such as ethylene carbonate (EC), propylene carbonate (PC), and butylene carbonate (BC), and linear esters (linear carbonates) such as dimethyl carbonate (DMC), diethyl carbonate (DEC), and ethyl methyl carbonate (EMC). The electrolytic solution preferably contains two or more solvents.

### Conductive Aid

The conductive aid is not particularly limited. For example, the conductive aid may be Vapor Grown Carbon Fiber (VGCF) and acetylene black (AB), Ketjen black (KB), carbon nanotubes (CNT), carbon nanofibers (CNF), and the like, but is not limited thereto.

### Binder

The binder is not particularly limited. For example, the binder may be a material such as, but not limited to, polyvinylidene fluoride (PVdF), butadiene rubber (BR), or styrene butadiene rubber (SBR), or a combination thereof.

The thickness of the cathode active material layer may be, for example, 0.1 to 1000 μm.

### Electrolyte Layer

The electrolyte layer contains at least an electrolyte. In addition, the electrolyte layer may contain a binder or the like as necessary in addition to the electrolyte. For the electrolyte and the binder, reference can be made to the above description of the cathode active material layer of the present disclosure.

The thickness of the electrolyte layer is, for example, 0.1 to 300 μm, and preferably 0.1 to 100 μm.

### Anode Active Material Layer

The anode active material layer is a layer containing an anode active material, an optional electrolyte, a conductive auxiliary agent, a binder, and the like.

The material of the anode active material is not particularly limited. For example, the anode active material is lithium cobaltate (LiCoO₂), lithium nickelate (LiNiO₂), lithium manganate (LiMn₂O₄), LiCo_{1/3}Ni_{1/3}Mn_{1/3}O₂, a heteroelement-substituted Li—Mn spinel having a composition represented by Li₁₊ₓMn_{2-x-y}MyO₄ (M is one or more metallic elements selected from Al, Mg, Co, Fe, Ni, and Zn), and lithium titanate (LiₓTiO_{y}), lithium metal phosphate (LiMPO₄, M is one or more metals selected from Fe, Mn, Co, and Ni), or the like, but is not limited thereto.

The anode active material may have a coating layer. The coating layer is a layer containing a material having lithium ion conductivity, having low reactivity with an anode active material or a solid electrolyte, and capable of maintaining a form of a coating layer that does not flow even when in contact with an active material or a solid electrolyte. In addition to LiNbO₃, Li₄Ti₅O₁₂, Li₃PO₄ may be exemplified, but is not limited thereto.

Examples of the shape of the anode active material include particles. The mean particle diameter (D50) of the anode active material is not particularly limited, but may be, for example, 10 nm or more and 100 nm or more. Meanwhile, the mean particle diameter (D50) of the anode active material is, for example, 50 μm or less, and may be 20 μm or less. The mean particle diameter (D50) can be calculated, for example, from measurements by means of a laser diffractometer, a scanning-electron-microscope (SEM).

For the electrolyte, the conductive auxiliary agent, and the binder, reference can be made to the above description of the cathode active material layer of the present disclosure.

When the anode active material layer contains a solid electrolyte, the mass ratio of the anode active material to the solid electrolyte in the anode active material layer (mass of the anode active material:mass of the solid electrolyte) is preferably 85:15 to 30:70, and more preferably 80:20 to 50:50.

The thickness of the anode active material layers is, for example, 0.1 μm to 1000 μm, preferably 1 μm to 100 μm, and more preferably 30 μm to 100 μm.

### Anode Current Collector Layer

The material used for the anode current collector layer is not particularly limited, and a material that can be used as an anode current collector of a battery can be appropriately employed. For example, materials used in the anode current collector layers may include, but are not limited to, SUS, nickel, chromium, gold, platinum, aluminum, iron, titanium, zinc, and the like, and metals thereof plated or deposited with nickel, chromium, carbon, and the like.

The shape of the anode current collector layer is not particularly limited, and may be, for example, a foil shape, a plate shape, or a mesh shape. Among the above, the foil shape is preferred.

The lithium-ion battery manufactured by the method of the present disclosure may be a liquid-based battery containing an electrolyte solution as an electrolyte layer, or may be a solid-state battery having a solid electrolyte layer as an electrolyte layer. In the context of the present disclosure, a “solid-state battery” means a battery that uses at least a solid electrolyte as an electrolyte. Therefore, the solid battery may use a combination of a solid electrolyte and a liquid electrolyte as the electrolyte. The solid-state battery of the present disclosure may be an all-solid-state battery, that is, a battery using only a solid electrolyte as an electrolyte.

The lithium-ion battery manufactured by the method of the present disclosure may be a primary battery or a secondary battery.

The shape of the lithium-ion battery, for example, coin-type, laminate-type, cylindrical, square-type.

### Synthesis of Porous Silicon Clathrate Electrode Active Materials

### Alloying

### Synthesis Example 1

A Si powder (high-purity science, SIEPB32) was prepared as a silicon (Si) source. Si powder and metallic lithium (Li) were weighed in molar proportions of Li/Si=4.0. The weighed Si powder and Li were mixed in a mortar in an argon-atmosphere to obtain a lithium-silicon (LiSi) alloy. The resulting LiSi was treated with hydrofluoric acid (HF) by reacting with ethanol. In this way, a Si powder having voids inside the primary particles, i.e., a Si powder having a porous structure, was obtained.

Sodium silicon (NaSi) alloys were prepared using porous Si powder and sodium hydride (NaH) as a source of sodium (Na). NaH was previously washed with hexane. NaH and Si powder having a porous structure were weighed to a molar ratio of 1.05:1, and the weighed NaH and Si powder having a porous structure were mixed in a cutter mill. The mixture was heated in an oven at 500° C. for 40 hours to obtain a powdery NaSi alloy.

### Clathrating

### Synthesis Example 1

The obtained NaSi alloy and aluminum fluoride (AlF₃) were weighed so as to have a molar ratio of 1:0.34, and the weighed NaSi alloy and AlF₃ were mixed by a cutter mill to obtain a reactive raw material. The obtained powdery reaction raw material was placed in a reaction vessel made of stainless steel, and heated in a heating furnace under an argon atmosphere at 340° C. for 60 hours to obtain a reaction product containing silicon clathrate particles. The resulting reaction product was acid-washed with a mixed solvent of HNO₃ and H₂O in a volume ratio of 10:90 to remove by-products in the reaction product. After washing, the filtered and filtered solids were dried at 120° C. for 3 hours or more to obtain a composition comprising the silicon clathrate particles of Synthesis Example 1 comprising a type I silicon clathrate and a type II silicon clathrate.

### Synthesis Examples 2 to 4

In the same manner as in Synthesis Example 1, a composition containing the silicon clathrate particles of Synthesis Examples 2 to 4 was obtained.

### Removal of Type I Silicon Clathrate

### Example 1

To the composition 2.2 g containing the silicon clathrate particles of Synthesis Example 1, ethanol 100 ml and an aqueous 46 wt % HF solution 3.71 ml were added, and the mixture was stirred. The solution was reacted by stirring for 3 hours to remove the type I silicon clathrate. The resulting solution was filtered and the filtrated solids were washed 8 times with ethanol 20 ml. After washing, the material was dried at 60° C. overnight to obtain the silicon clathrate electrode active material of Example 1.

### Examples 2 and 3

The silicon clathrate electrode active materials of Examples 2 and 3 were obtained in the same manner as in Example 1 except that the composition containing the silicon clathrate particles of Synthesis Examples 2 and 3 was used. In each of the embodiments, the numbers of the embodiments correspond to the numbers of the composite examples.

### Example 4

To the composition 2.2 g containing the silicon clathrate particles of Synthesis Example 4, an aqueous 20 ml, an ethanol 75 ml, and an aqueous 46 wt % HF solution 4.5 ml were added, and the mixture was stirred. The solution was reacted by stirring for 3 hours to remove the type I silicon clathrate. The resulting reactant was filtered and the filtered solids were washed three times with an aqueous 50 ml and then once with an ethanol 20 ml. After washing, the material was dried at 120° C. overnight to obtain the silicon clathrate electrode active material of Example 4.

### Comparative Example 1

The composition containing the silicon clathrate particles of Synthesis Example 1 was used as the silicon clathrate electrode active material of Comparative Example 1 without removing the type I silicon clathrate.

### Evaluation Results

The content ratio of the respective components and the ratio of the mass of type II silicon clathrate to the total mass of the type I silicon clathrate and the type II silicon clathrate in the composition containing the silicon clathrate particles are shown in Table 1 (before removal of type I in the table). The ratio of the components was calculated from the ratio of the peak intensities measured by XRD. In of Table 1, “type II” indicates a type II silicon clathrate, and “type I” indicates an type I silicon clathrate.

The content ratio of the respective components and the ratio of the mass of type II silicon clathrate to the total mass of the type I silicon clathrate and type II silicon clathrate in the silicon clathrate electrode active material are shown in Table 1 and (after removing the type I in the table).

Pore increments below 100 nm after removal of the type I silicon clathrate were calculated as differences in the amount of pores before and after the type I silicon clathrate removal step. In Example 1, the amount of pores increased was less than or equal to 0.0661 cc/g (100 nm). In addition, the results of Examples 1 to 4 are shown in Table 1 for the increased amount of pores. The value of the pore increase amount in Examples 2 to 4 is shown as a relative value when the value of Example 1 is set to 100.

TABLE 1

| | Prior to type I removal | | | | | After removal of type I | | | | | | Pore growth |
|---|---|---|---|---|---|---|---|---|---|---|---|---|
| | | | | | type II/ | | | | | type II/ | | below 100 nm |
| | | | | | (type I + | | | | | (type I + | | after type I |
| | Content (% by mass) | | | | type II) | Content (% by mass) | | | | type II) | Type I | depletion |
| | Type II | Type I | Na₂SiF₆ | Other | (%) | Type II | Type I | Na₂SiF₆ | Other | (%) | reductions | (relative) |
| Comparative | 88.2 | 6.66 | 0 | 5.2 | 93.0 | — | — | — | — | — | — | — |
| Example 1 | | | | | | | | | | | | |
| Example 1 | 88.2 | 6.66 | 0 | 5.2 | 93.0 | 88.3 | 0.6 | 0.9 | 10.2 | 99.3 | 6.3 | 100.0 |
| Example 2 | 92.8 | 6.8 | 0 | 0.3 | 93.2 | 97.1 | 0.3 | 2.6 | 0 | 99.7 | 6.5 | 121.2 |
| Example 3 | 85.2 | 7.2 | 0 | 7.6 | 92.2 | 85.9 | 0.4 | 6.8 | 6.9 | 99.5 | 7.3 | 216.2 |
| Example 4 | 91.3 | 7.96 | 0 | 0.78 | 92.0 | 98.6 | 0.5 | 0 | 0.9 | 99.5 | 7.5 | 185.9 |

As shown in Table 1, for the silicon clathrate electrode active material obtained by the disclosed process, the content ratio of type II silicon clathrate was increased, and the content of the pores below 100 nm was increased.

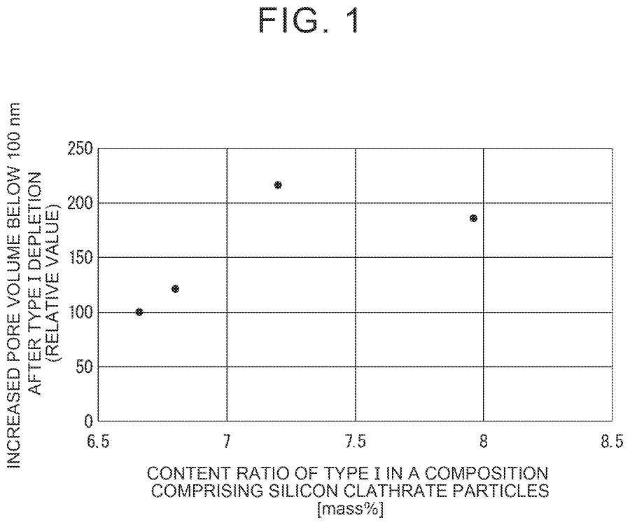

FIG. 1 is a diagram showing the relation between the content ratio of the type I silicon clathrate in the composition containing the silicon clathrate particles and the increased amount of the pores below 100 nm after removing the type I silicon clathrate. As shown in FIG. 1, when the content ratio was within the scope of the present disclosure, the increased amount of the pores below 100 nm after removing the type I silicon clathrate was large. In FIG. 1, “type I” indicates a type I silicon clathrate.

What is claimed is:

1. A production method of a porous silicon clathrate electrode active material, the production method comprising:
(a) providing a composition including silicon clathrate particles containing a type I silicon clathrate and a type II silicon clathrate; and
(b) removing at least part of the type I silicon clathrate to form pores in the silicon clathrate particles, or to increase pores in the silicon clathrate particles.

2. The production method according to claim 1, wherein a proportion of mass of the type I silicon clathrate as to a total mass of the composition containing the silicon clathrate particles is 5.0% by mass or more.

3. The production method according to claim 1, wherein in (b), the silicon clathrate particles are brought into contact with a hydrogen fluoride solution to remove at least part of the type I silicon clathrate.

4. The production method according to claim 3, wherein a solvent of the hydrogen fluoride solution is a mixed solvent of water and an organic solvent.

5. The production method according to claim 1, wherein the silicon clathrate electrode active material is used for a cathode active material of a lithium-ion battery.

6. A production method of a lithium-ion battery, the production method comprising:
producing a silicon clathrate electrode active material by the production method according to claim 1; and
forming an electrode active material layer containing the silicon clathrate electrode active material.
